(19) United States
(12) Patent Application Publication
(10) Pub. No.: US 2011/0054870 A1
(43) Pub. Date: Mar. 3, 2011

(54) Vision Based Human Activity Recognition and Monitoring System for Guided Virtual Rehabilitation

(75) Inventors: Behzad Dariush, Sunnyvale, CA (US); Kikuo Fujimura, Palo Alto, CA (US); Yoshiaki Sakagami, Mountain View, CA (US)

(73) Assignee: HONDA MOTOR CO., LTD., Tokyo (JP)

(21) Appl. No.: 12/873,498

(22) Filed: Sep. 1, 2010

Related U.S. Application Data
(60) Provisional application No. 61/239,387, filed on Sep. 2, 2009.

(51) Int. Cl. G06G 7/48; H04N 13/02

(52) U.S. Cl. 703/11; 348/46; 348/E13.074

(57) ABSTRACT

A system, method, and computer program product for providing a user with a virtual environment in which the user can perform guided activities and receive feedback are described. The user is provided with guidance to perform certain movements. The user's movements are captured in an image stream. The image stream is analyzed to estimate the user's movements, which is tracked by a user-specific human model. Biomechanical quantities such as center of pressure and muscle forces are calculated based on the tracked movements. Feedback such as the biomechanical quantities and differences between the guided movements and the captured actual movements are provided to the user.

### RELATED APPLICATIONS

This application claims the benefit of U.S. Provisional Application No. 61/239,387, filed Sep. 2, 2009, the content of which is incorporated by reference herein in its entirety.

### BACKGROUND

1. Field of Disclosure

The disclosure generally relates to the field of healthcare, and more specifically to assisted rehabilitation.

2. Description of the Related Art

Goal directed and task-specific training is an activity-based approach frequently used in therapy. Patient specific goals have been shown to improve functional outcome. However, it is often difficult to maintain the patient's interest in performing repetitive tasks and ensuring that they complete the treatment program. Since loss of interest can impair the effectiveness of the therapy, the use of rewarding activities has been shown to improve people's motivation to practice. Since the primary goal of a patient practicing a rehabilitation program is to make sure that the program is done correctly, what is needed, inter alia, is a system and method for tracking the patient's rehabilitation activities and providing feedback for the activities.

### SUMMARY

Embodiments of the present invention provide a method (and corresponding system and computer program product) for providing a user with a virtual environment in which the user can perform guided activities and receive feedback. The method provides the user with guidance to perform certain movements, and captures the user's movements in an image stream. The image stream is analyzed to estimate the user's movements, which is tracked by a user-specific human model. Biomechanical quantities such as center of pressure and muscle forces are calculated based on the tracked movements. Feedback such as the biomechanical quantities and differences between the guided movements and the captured actual movements are provided to the user.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

FIG. 1A is a block diagram illustrating a virtual rehabilitation system for providing patients with guided rehabilitation programs and feedback in accordance with one embodiment of the invention.

FIG. 1B is a flow diagram illustrating an operation of the virtual rehabilitation system shown in FIG. 1 in accordance with one embodiment of the invention.

FIG. 2 is a block diagram illustrating a configuration of a pose tracking module shown in FIG. 1A in accordance with one embodiment of the invention.

FIG. 3 is a block diagram illustrating a configuration of a biomechanical model module shown in FIG. 1A in accordance with one embodiment of the invention.

FIG. 4 is a diagram illustrating a human model in accordance with one embodiment of the invention.

FIGS. 5A and 5B are diagrams illustrating force transformation to compute a center of pressure (COP) in accordance with one embodiment of the invention.

FIG. 6 is a diagram illustrating a model describing musculo-tendon contraction mechanics in accordance with one embodiment of the invention.

### DETAILED DESCRIPTION

The present invention provides a system (and corresponding method and computer program product) for providing an immersive virtual environment for a patient to engage in rehabilitation activities. The system provides a graphical user interface (GUI) for demonstrating the rehabilitation activities, captures the patient's activities, and tracks the captured activities on a human model. The system determines biomechanical quantities of the captured activities by analyzing the tracked activities, and provides feedback through the GUI to the patient based on the determined quantities.

The Figures (FIGS.) and the following description relate to embodiments of the present invention by way of illustration only. Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

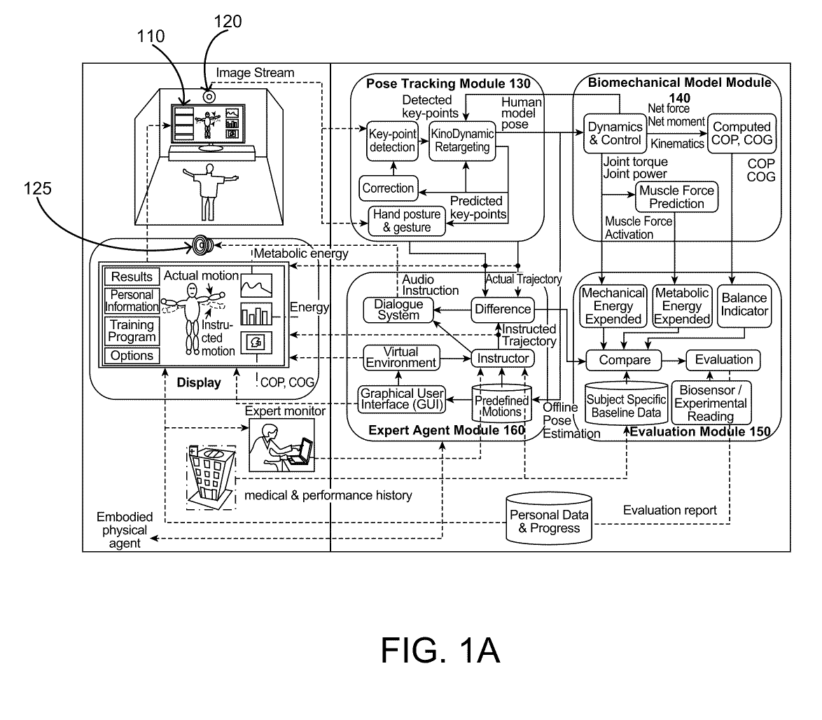

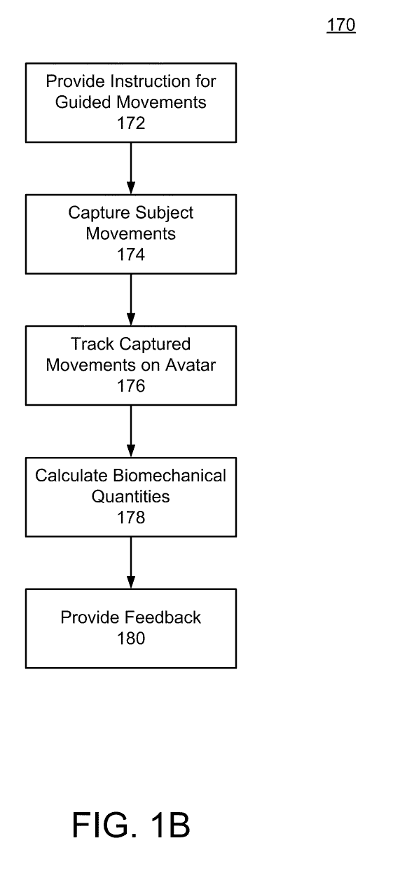

FIG. 1A is a block diagram illustrating a virtual rehabilitation system 100 for providing a patient with a virtual environment in which the patient can participate in guided rehabilitation programs and receive feedback according to one embodiment. As shown, the virtual rehabilitation system 100 includes a display 110, a video camera 120, and a speaker 125 connected with one or more of the following inter-connected control modules: a pose tracking module 130, a biomechanical model module 140, an evaluation module 150, and an expert agent module 160.

In order to participate in a guided rehabilitation program, the patient (also called “user”, “subject”) stands in front of the video camera 120 and the display 110. The display 110 and the speaker 125 function as the virtual environment used for instructing the user to perform goal-directed movements specified by the expert agent module 160. These instructions may be in the form of voice commands (e.g., through a speech and dialogue system) and/or through motion commands which are graphically displayed to the user by means of a three-dimensional (3D) virtual avatar (also called a “human model”). The video camera 120 captures the user's movements and passes the image stream to the pose tracking module 130, which records the user's movements during execution of an instruction. In one embodiment, the video camera 120 is a time-of-flight (TOF) camera and the image stream transmitted to the pose tracking module 130 is a depth image stream.

The pose tracking module 130 estimates the user's pose (and movements) in the image stream and tracks the user's pose (and movements) in the 3D virtual avatar. The pose tracking module 130 estimates/tracks the pose of the whole body and/or a specific region, such as the hands. The output of the pose tracking module 130, corresponding to the degrees of freedom (DOF) of the virtual avatar, is used as input to the biomechanical model module 140 in order to compute physical quantities (e.g., estimated net joint torques, joint powers, mechanical energy, joint force, and joint stress required to execute the estimated movements, center of pressure, center of gravity) and/or physiological quantities (e.g., muscular force, metabolic energy, calories expended, heat rate, and fatigue) associated with the estimated movements of the subject (also called the “reconstructed movements”). The biomechanical model module 140 estimates these quantities by applying techniques such as muscle modeling and optimization techniques.

The evaluation module 150 displays the reconstructed movements through the 3D virtual avatar, along with some of the physical/physiological quantities on the display 110 as bio-feedback to the patient. Any difference (or error) between the instructed movements and the reconstructed movements may also be displayed. The displayed difference/error may be amplified (or exaggerated) in order to make the patient more challenged in executing the intended task.

FIG. 1B is a flow diagram illustrating a process 170 for the virtual rehabilitation system 100 to provide a patient with a guided rehabilitation program and feedback according to one embodiment. Other embodiments can include different and/or additional steps than the ones described herein. As shown, the virtual rehabilitation system 100 provides 172 the patient with instructions for guided rehabilitation movements and captures 174 the patient's movements through the video camera 120. The virtual rehabilitation system 100 estimates and tracks 176 the captured movements on the 3D virtual avatar, calculates 178 biomechanical quantities of the tracked movements, and provides 180 feedback about the captured movements back to the patient.

### Human Model (3D Virtual Avatar)

The virtual rehabilitation system 100 uses a subject-specific human model to reconstruct the human pose (and movements) of a subject from a set of low-dimensional motion descriptors (or key-points). The human model is a human anatomical model that can closely resemble the body of the subject. The human model is configured based on appropriate kinematic model parameters such as anthropometric dimensions, joint ranges, and a geometric (mesh, or computer-aided design (CAD)) model of each body part of the subject. The anthropometric dimensions are used to appropriately fit the data to a subject specific model. The anthropometric data for the subject can be measured offline. The approximate anthropometric measurements can be obtained offline or online when the subject stands in front of the video camera 120 and the limb dimensions are approximated. The per-segment data may also be estimated based on simple parameters, such as total body height and body weight based on statistical regression equations.

The human model is also configured based on appropriate dynamic model parameters such as segment parameters for each limb, including location of center of gravity, segment mass, and segment inertia. The approximate dynamic parameter data for the subject may be available from the kinematic model parameters based on statistical regression equations. See David Winter, “Biomechanics and Motor Control of Human Movement”, 2nd Edition (1990), John Wiley and Sons, Inc., the content of which is incorporated by reference herein in its entirety.

### Pose Tracking Module

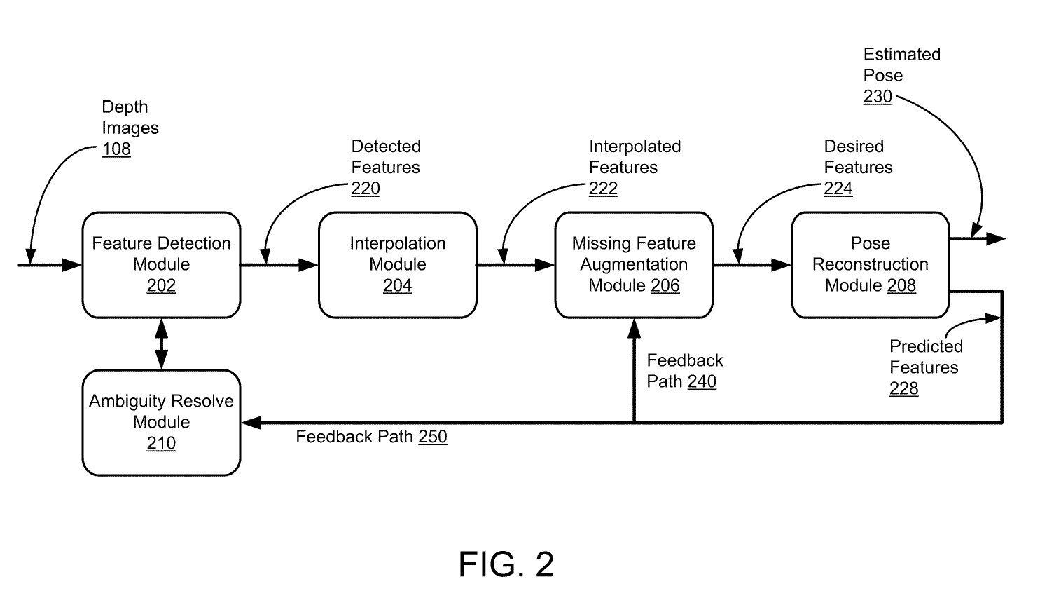

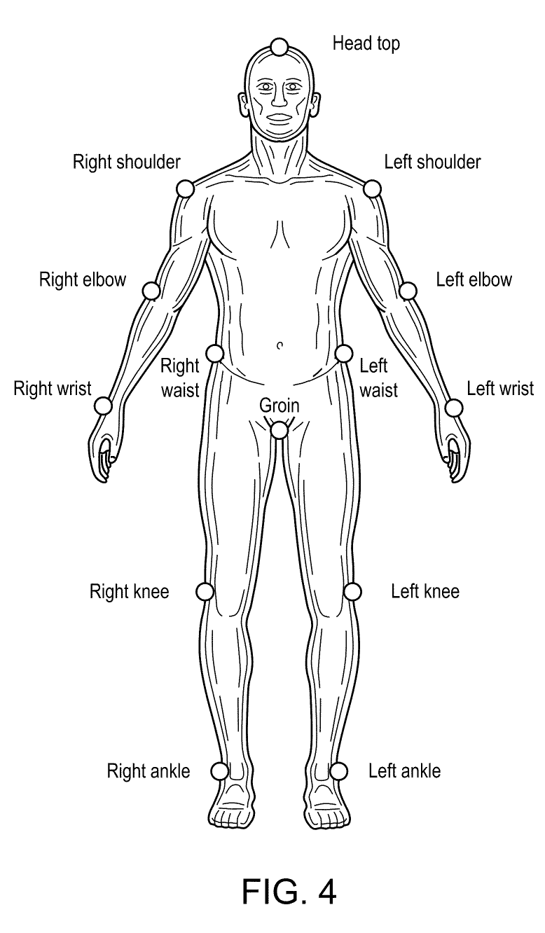

FIG. 2 is a block diagram illustrating a configuration of the pose tracking module 130 for estimating subject poses (and movements) and reconstructing the pose (and movements) in a subject-specific human model according to one embodiment. The pose tracking module 130 reconstructs body poses of the subject (or user, patient) from multiple features detected in the image stream 108. The features (or feature points, anatomical features, key points) correspond to 3D positions of prominent anatomical landmarks on the human body. Without loss of generality, in one embodiment the pose tracking module 130 tracks fourteen (k=14) such body features as illustrated in FIG. 4. As shown, the fourteen features are head top, left shoulder, right shoulder, left elbow, right elbow, left wrist, right wrist, left waist, right waist, groin, left knee, right knee, left ankle, and right ankle. The reconstructed (or estimated) human pose q is described in the human model that tracks the subject's pose.

As shown in FIG. 2, the pose tracking module 130 comprises a feature detection module (also called a key-point detection module) 202, an interpolation module 204, a missing feature augmentation module 206, a pose reconstruction module (also called a constrained closed loop inverse kinematics module) 208, and an ambiguity resolve module 210.

The feature detection module 202 is configured to receive a depth image stream 108, detect features in the depth image stream 108, and output the detection results. Due to occlusions, unreliable observations, or low confidence in the detection results, the actual number of detected features for a particular image frame, denoted by m (m=0 . . . k), may be fewer than k. The detected features are represented by a position vector p_{det} 220, which is formed by concatenating the 3D position vectors corresponding to the individual detected features. In one embodiment, the feature detection module 202 first samples contour points on human silhouettes segmented from frames in the depth image stream 108, and then detects feature points in the sample contour points by comparing their Inner Distance Shape Context (IDSC) descriptors with IDSC descriptors of known feature points for similarity.

The interpolation module 204 is configured to low pass filter the vector p_{det} 220 received from the feature detection module 202 and generate interpolated features P̅_{det} 222. In one embodiment, the depth images transmitted to the pose tracking module 130 is captured at approximately 15 frames per second using a TOF camera 120 (e.g., a Swiss Ranger SR-3000 3D time of flight camera). For stability in numerical integrations performed in the pose reconstruction module 208 in subsequent modules, the interpolation module 204 re-samples the detected features to a higher rate (e.g., 100 HZ) and represented by the vector P̅_{det} 222.

The missing feature augmentation module 206 is configured to augment P̅_{det} 222 with positions of features missing in the depth image stream 108 and generate a desired (or augmented) feature vector, denoted by p_{d} 224. As noted above, the number of detected features at each frame may be fewer than the total number of tracked body features, fourteen in this example (i.e. m<k=14) due to occlusions or unreliable observations. The missing feature augmentation module 206 receives the predicted features p 228 from the pose reconstruction module 208 through a feedback path 240 and utilizes p 228 to augment the missing features. The augmented features p_{d} 224 represents the k=14 desired features used as input to the pose reconstruction module 208.

The pose reconstruction module 208 is configured to generate estimated poses q 230 and predicted features p 228 based on p_{d} 224, the subject-specific human model, and its constraints. The pose reconstruction module 208 is further configured to transmit p 228 to the missing feature augmentation module 206 and the ambiguity resolve module 210 to resolve subsequent ambiguities and to estimate intermittently missing or occluded features. The estimated (or reconstructed, recovered) pose, parameterized by the vector q 230, describes the predicted motion and pose of all n DOF in the human model. The predicted features p 228 are fed-back to the missing feature augmentation module 206 to augment intermittently missing or occluded features, and to the ambiguity resolve module 210 to resolve ambiguities in case multiple feature candidates are detected.

The ambiguity resolve module 210 is configured to resolve ambiguities when the feature detection module 202 detects multiple possible feature candidates. The ambiguity resolve module 210 receives the predicted features p 228 from the pose reconstruction module 208 through a feedback path 250 and utilizes p 228 to resolve the ambiguities. For example, p 228 may indicate that the hypothesized location of one candidate for a feature (i.e., from the feature detection module 202) is highly improbable, causing the ambiguity resolve module 210 to select another candidate of the feature as the detected feature. As another example, the ambiguity resolve module 210 may choose the feature candidate that is closest to the corresponding predicted feature to be the detected feature. Alternatively or additionally, the ambiguity resolve module 210 may use the predicted feature as the detected feature.

The pose tracking module 130, or any of its components described above, may be configured as software (e.g., modules that comprise instructions executable by a processor), hardware (e.g., an application specific integrated circuit), or a combination thereof. The software and/or hardware may operate in a computer system that is structured to include a processor, memory, computer-readable storage medium (e.g., hard drive), network interfaces, and applicable operating system and other functional software (e.g., network drivers, communication protocols). Those of skill in the art will recognize that other embodiments can have different and/or additional modules than those shown in FIG. 2. Likewise, the functionalities can be distributed among the modules in a manner different than described herein. Further, some of the functions can be provided by entities other than the pose tracking module 130. Additional information about the pose tracking module 130 are available in U.S. patent application Ser. No. 12/709,221, the content of which is incorporated by reference herein in its entirety.

### Biomechanical Model Module

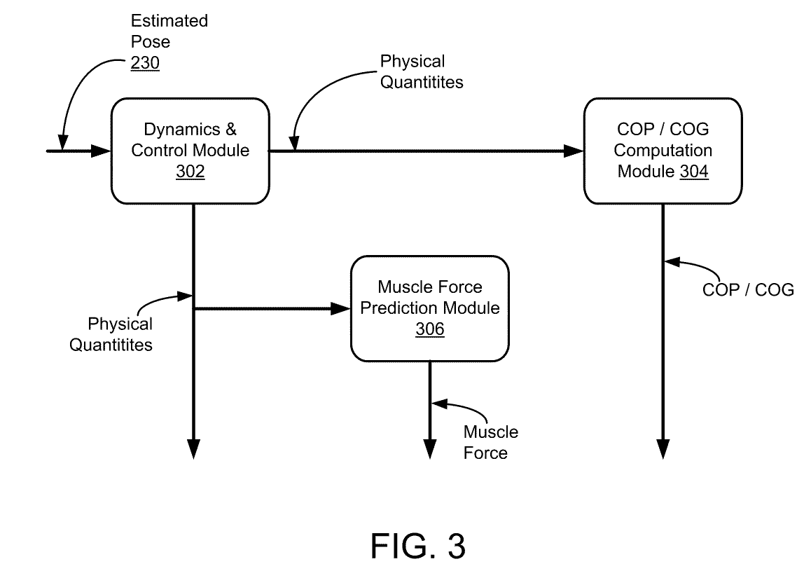

FIG. 3 is a block diagram illustrating a configuration of the biomechanical model module 140 for determining biomechanical quantities of the estimated movements (and pose) reconstructed on the 3D virtual avatar according to one embodiment. As shown, the biomechanical model module 140 includes a dynamics and control module 302, a COP/COG computation module 304, and a muscle force prediction module 306.

The dynamics and control module 302 is configured to receive a stream of estimated poses q 230, calculate physical quantities (e.g., joint torques, joint powers, net forces, net moments, and kinematics), and output the physical quantities to the COP/COG computation module 304, the muscle force prediction module 306, and the evaluation module 150. The subject's body can be modeled as a set of N+1 links interconnected by N joints, of up to six DOF each, forming a tree-structure topology. The movements of the links are referenced to a fixed base (inertial frame) which is labeled 0 while the links are labeled from 1 through N. The inertial frame is attached to the ground.

The spatial velocity and acceleration of link i are represented as:

$$\begin{matrix}{v}_{i} = [ \begin{matrix}{ω}_{i} \\ {\vec{v}}_{i}\end{matrix} ] , & ( 1 ) \\ {a}_{i} = [ \begin{matrix}{\dot{ω}}_{i} \\ {{v}^{\dot{\to }}}_{i}\end{matrix} ] , & ( 2 )\end{matrix}$$

where ωᵢ, \vec{v}ᵢ, \dot{ω}ᵢ, and {right arrow over (\dot{v}ᵢ are the angular velocity, the linear velocity, the angular acceleration, and the linear acceleration of link i, respectively, as referenced to the link coordinate frame.

In order to model a user on the fly, one of the links is modeled as a floating base (typically the torso) and numbered as link l. A fictitious six DOF joint is inserted between the floating base and the fixed base. The total number of DOF in the humanoid is n where n=Σnᵢ, and nᵢ is the number of DOF for joint i which connects link i to its predecessor. Note that n includes the six DOFs for the floating base.

The spatial force acting on link i from its predecessor is represented as:

$${f}_{i} = [ \begin{matrix}{n}_{i} \\ {f}_{i}\end{matrix} ] , \qquad ( 3 )$$

where nᵢ is the moment about the origin of the link coordinate frame, and fᵢ is the translational force referenced to the link coordinate frame.

The spatial coordinate transformation matrix ⁱXⱼ may be composed from the position vector ^{j}pᵢ from the origin of coordinate frame j to the origin of i, and a 3×3 rotation matrix ⁱRⱼ which transforms 3D vectors from coordinate frame j to i:

$${}_{}^{i}{X}{}_{j}^{} = [ \begin{matrix}{}_{}^{i}{R}{}_{j}^{} & {0}_{3 \times 3} \\ {}_{}^{i}{R}{}_{j}^{} {S ( {}_{}^{j}{p}{}_{i}^{} )}^{T} & {}_{}^{i}{R}{}_{j}^{}\end{matrix} ] . \qquad ( 4 )$$

The quantity S(p) is the skew-symmetric matrix that satisfies S(p)ω=p×ω for any 3D vector ω. This transformation matrix can be used to transform spatial quantities from one frame to another as follows:

vⱼ=^{j}Xᵢvᵢ, (5)

aⱼ=^{j}Xᵢaᵢ, (6)

fⱼ=^{j}Xᵢ^{-T}fᵢ. (7)

The equations of motion of a robotic mechanism in joint-space can be written as:

τ=H(q)\ddot{q}+C(q,\dot{q})\dot{q}+τ_{g}(q)+J^{T}f₂, (8)

where q, \dot{q}, \ddot{q}, and τ denote n-dimensional generalized vectors of joint position, velocity, acceleration and force variables, respectively. H(q) is an (n×n) joint-space inertia matrix. C is an (n×n) matrix such that C\dot{q} is the vector of Coriolis and centrifugal terms. τ_{g} is the vector of gravity terms. J is a Jacobian matrix, and fₑ is the external spatial force acting on the system. When the feet are the only contacts for the subject with the environment, the external force includes the foot spatial contact forces (ground reaction force/moment),

$${f}_{e} = [ \begin{matrix}{f}_{R} \\ {f}_{L}\end{matrix} ] , \qquad ( 9 )$$

where f_{R}, and f_{L} are the right and left foot spatial contact forces, respectively. Friction and disturbance inputs can easily be added to these equations as well.

In the Inverse Dynamics (ID) problem, given the desired joint accelerations, the joint torques τ are computed using Equation 8, where the torques can be computed as a function of the joint motion q, its first and second derivatives \dot{q}, \ddot{q}, and the left and right foot spatial contact forces f_{L} and f_{R}:

τ=ID(q, \dot{q}, \ddot{q}, f_{R}, f_{L}), (10)

and

τ=[τ_{UB}^{T} fₜ^{T} τ_{R}^{T} τ_{L}^{T}]^{T}, (11)

where τ_{UB}, τ_{R}, and τ_{L} are the joint torques for the upper body, right leg, and left leg, respectively. fₜ is the force on the torso (the floating-base link), and it will be zero if the external (foot) forces are consistent with the given system acceleration since the torso is not actuated. In one embodiment, the very efficient O(n) Recursive Newton-Euler Algorithm (RNEA) is applied to calculate the quantities. The RNEA is efficient because it calculates most of the quantities in local link coordinates and it includes the effects of gravity in an efficient manner.

The COP/COG computation module 304 is configured to receive physical quantities (e.g., net forces, net moments, and kinematics) from the dynamics and control module 302, calculate the center of gravity and/or the center of pressure (COP), and output the calculated results to the evaluation module 150. The Center of Mass (COM) is a point equivalent of the total body mass with respect to the global coordinate system. The COM is the weighted average of the COM of each body segment in 3D space. The vertical projection of the COM onto the ground is called the center of gravity (COG). The COP is defined as the point on the ground at which the resulting ground reaction forces act. The COP represents a weighted average of all the pressures over the surface area in contact with the ground. If only one foot is on the ground, the net COP lies within that foot. If two feet are on the ground, the net COP lies somewhere between the two feet. Balance of the human body requires control of the position and motion of the COG and the COP relative to the base of support. Thus, the COP and the COG are useful indicators of balance and can be used as bio-feedback for therapy for people who have deficits in maintaining balance.

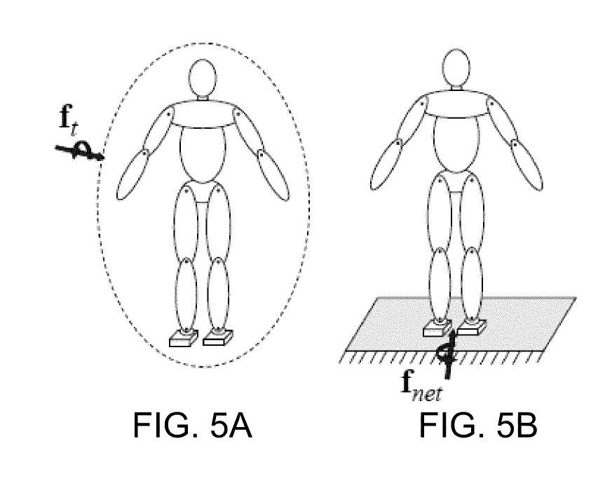

FIGS. 5A and 5B are diagrams illustrating force transformation to compute the COP. FIG. 5A shows a human model receiving a force fᵢ, and FIG. 5B shows a net force fₙₑₜ of the human model on the feet. If the resultant (net) spatial force fₙₑₜ=[nₙₑₜ^{T}fₙₑₜ^{T}]^{T} is known as in FIG. 5B, then the COP position may be computed as ⁰p_{cop}^{x}=−nₙₑₜ^{y}/fₙₑₜ^{z}, and ⁰p_{cop}^{y}=−nₙₑₜ^{x}/fₙₑₜ^{z}. The COG can be calculated using the following equation

$${p}_{cog} = \frac{1}{M} {\sum }_{i = 1}^{N} {m}_{i} {p}_{i} ,$$

where, N is the total number of body segments, M is the total mass of all body segments, mᵢ is the mass of segment i and pᵢ is the vector originating from the base and terminating at the center of mass of segment i.

An algorithm for determining the resultant foot force (force and moment) for a given whole-body system acceleration is described in detail below. By solving the inverse dynamics problem using the Recursive Newton-Euler Algorithm (RNEA) for a given system acceleration while applying zero foot forces (free-space inverse dynamics), the resultant spatial force on the system (the torso in the case of RNEA) can be computed as in FIG. 5A. According to Newton's laws of motion, this spatial force can be applied to any body of the system. Therefore, if it is transformed into the inertial frame (ground), the resultant ground reaction force (resultant foot force) will be obtained (FIG. 5B) and then the COP position is computed. The algorithm is summarized in the table below. Note that the resulting algorithm is efficient because the main computation is the RNEA for inverse dynamics for the 3D virtual avatar.

Input: model, q, \dot{q}, \ddot{q}
Output: ⁰p_{cop}
Begin

τ=ID(q,\dot{q},\ddot{q},0,0);
fₙₑₜ=⁰Xₜ^{-T} fₜ;
⁰p_{cop}^{z}=0;
⁰p_{cop}^{x}=−nₙₑₜ^{y}/fₙₑₜ^{z};
⁰p_{cop}^{y}=nₙₑₜ^{x}/fₙₑₜ^{z};

End

The muscle force prediction module 306 is configured to receive physical quantities (e.g., joint torques and joint powers) from the dynamics and control module 302, calculate corresponding muscle forces incurred to generate the joint torques and joint quantities, and output the calculated results to the evaluation module 150. In order to calculate the muscle forces, the muscle force prediction module 306 models the muscle and tendon mechanics as active force-generating elements in series (tendon) and parallel (passive muscle stiffness) with elastic elements.

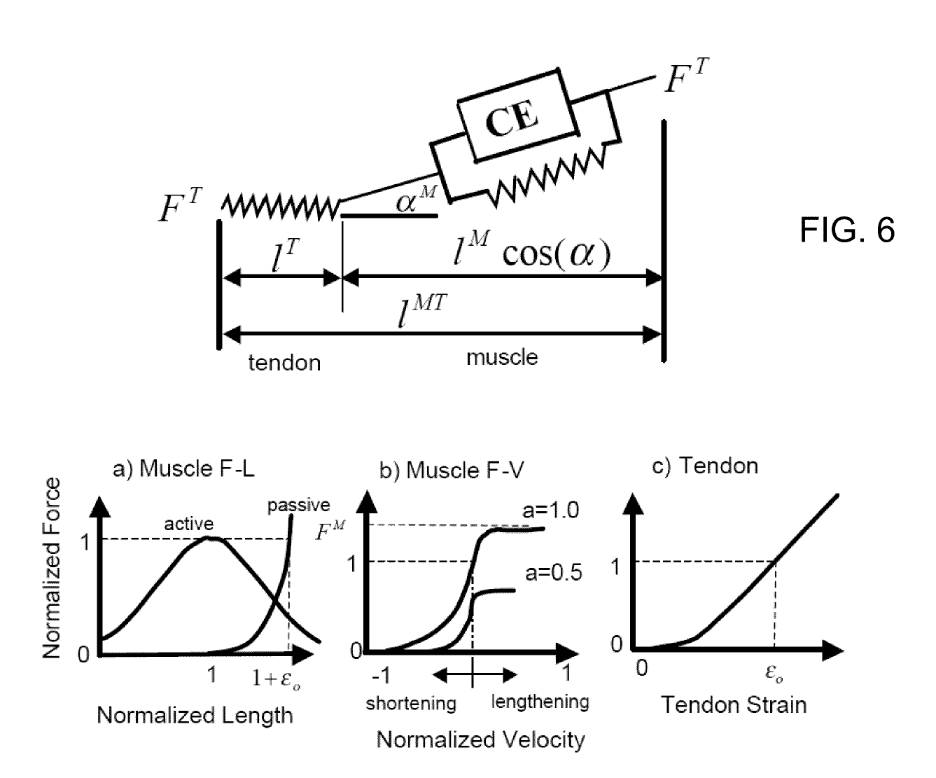

FIG. 6 shows a Hill-type model describing musculo-tendon contraction mechanics. The model consists of a muscle contractile element in series and parallel with elastic elements. As shown in chart (a) of FIG. 6, the active force-length of muscle is maximum at an optimal fiber length and falls off at lengths shorter or longer than optimum. Passive muscle force increases exponentially when the fiber is stretched to lengths beyond optimal fiber length. As shown in chart (b) of FIG. 6, when shortening, the active force output of a muscle is lower than it would be when isometric. Force output increases above isometric levels when the muscle fiber is lengthening. As shown in chart (c) of FIG. 6, tendon force was assumed to increase exponentially with strain during an initial toe region, and linearly with strain thereafter.

As illustrated in FIG. 6, the mechanical properties of the active and passive elements are described by nonlinear functions, which account for the length dependent nature of muscle force capacity, the passive mechanics of muscle and tendon as well as the force-velocity dependence of muscle. In one embodiment, the muscle force prediction module 306 uses a generic musculo-tendon model that is scaled to individual muscles using four muscle specific parameters:
Fₒ^{M}: maximum isometric force capacity of muscle,
lₒ^{M}: optimal muscle fiber length,
αₒ^{M}: muscle fiber pennation angle at optimal fiber length, and
lₛ^{T}: tendon slack length.
   Additional information about the generic musculo-tendon model are available in F. E. Zajac, “Muscle and tendon: properties, models, scaling, and application to biomechanics and motor control”, Critical Reviews in Biomedical Engineering (1989), 17(4):359-411, the content of which is incorporated by reference herein in its entirety.

In one embodiment, the muscle and tendon constitutive relationships can be specified numerically in a muscle input file. The various relationships (muscle force-muscle length, muscle force-muscle velocity, and tendon force-tendon length) are stored in normalized form so that they can be scaled by the muscle specific parameters above. The functions are represented as a finite set of sample points that are then interpolated by a natural cubic spline to create the functions. The muscle parameters allow subject-specific models of muscle to be created. They are typically obtained from live subjects by performing various strength tests at maximum voluntary activation. Other parameters are estimated from measuring sarcomere units in muscle tissue. The lines of action of musculo-tendon actuators are specified by describing the location of attachment points to the bones. See S. L. Delp and J. P. Loan, “A graphics-based software system to develop and analyze models of musculoskeletal structures”, Comput. Biol. Med. (1995), 25(1):21-34, the content of which is incorporated by reference herein in its entirety. These attachment points are in the local coordinate system of each bone and are transformed into world coordinates by multiplying the transformation matrices of the joint skeleton hierarchy. The muscle is then represented as a set of parameters specific to the muscle force model being utilized.

### Musculo-Tendon Properties

The force output of muscle depends on the fiber length, velocity, and activation level. Musculo-tendon length and velocity are estimated from the skeletal kinematics. That is, the joint angles and angular velocities can be used to compute the overall length and velocity of the n-line segments composing the geometric representation of the actuator:

$$\begin{matrix}{l}^{MT} = {\sum }_{i = 1}^{n} {l}_{i} , & ( 12 ) \\ {v}^{MT} = {\sum }_{i = 1}^{n} {v}_{i} . & ( 13 )\end{matrix}$$

In general, the overall shortening (lengthening) of a musculo-tendon actuator can be due to shortening (lengthening) of the muscle, shortening (lengthening) of the tendon or some combination thereof. Since in general the tendon is much stiffer than the muscle and thus shortens (lengthens) substantially less, it is assumed that the muscle shortening accounts for the overall velocity of the actuator. With this assumption, the following equation stands:

v^{M}=v^{MT} cos α. (14)

Of note is that the fiber velocity is actually less than the overall musculo-tendon velocity for a pennate muscle. Given the relationship between muscle and tendon force (F^{T}=F^{M} cos α), it can be seen that the assumed velocity relationship preserves equivalence between the power output of the muscle and musculo-tendon actuator:

P=F^{MT}V^{MT}=F^{M}V^{M}. (15)

For a given fiber length, velocity and activation level, the muscle fiber force can be computed from the following force-activation-length-velocity relationship:

F^{M}=F^{CE}(a,l^{M},v^{M})+F^{PE}(l^{M}), (16)

where F^{CE} is the active force developed by the contractile element and F^{PE} is the force due to passive stretch of the muscle fiber.

### Musculo-Tendon Force

A biomechanics problem faced by the biomechanical model module 140 is to compute the force output of a musculo-tendon actuator given the current state (joint positions and velocities) of the skeleton and the activation level of a muscle. Since there is no direct analytical solution to this problem, a numerical procedure is used to compute a muscle fiber length that enables force equilibrium between the fiber and tendon:

F^{T}=F^{M} cos α. (17)

More specifically, the procedure starts with an initial guess of the muscle fiber length, with the optimal fiber length (lₒ^{M}) being a good starting point. Fiber length can then be used to compute the tendon strain and corresponding tendon force using the force-strain relationship of tendon:

$${F}^{T} = {f}_{t} ( 1 - \frac{{l}^{MT} - {l}^{M}}{{l}^{T}} ) \cdot {F}_{o}^{M} . \qquad ( 18 )$$

Fiber length can also be used to compute the muscle fiber force due to passive and active components:

F^{M}=a·fᵥ(v^{M})·fₗ(l^{M})·Fₒ^{M}+fₚ(l^{M})·Fₒ^{M}. (19)

The force error at the current time instant (also called the “current force error”) can be computed in the fiber-tendon force equilibrium:

$${F}_{err} = {F}^{M} - \frac{{F}^{T}}{cos α} . \qquad ( 20 )$$

If the percentage force error is greater than some specified tolerance

$$( \frac{{F}_{err}}{{F}_{o}^{M}} > tol ) ,$$

the fiber length is adjusted using the current force error divided by the sum of the tangential stiffness of muscle and tendon:

$${dl}^{M} = \frac{{F}_{err}}{{k}^{CE} + {k}^{PE} + \frac{{k}^{T}}{cos α}} , \qquad ( 21 )$$

where k^{CE} is the gradient of the active muscle force-length function, k^{PE} is the gradient of the passive force-length function, and k^{T} is the gradient of the tendon force-length relationship. The gradients can be computed numerically by spline fitting the normalized force-length data for muscle and the normalized force-strain relationship for tendon, as specified in the muscle file. More specifically,

$$\begin{matrix}{k}^{CE} = \frac{\partial {f}_{l}}{\partial \overline{l}} \cdot \frac{{F}_{o}^{M}}{{l}_{o}^{M}} , & ( 22 ) \\ {k}^{PE} = \frac{\partial {f}_{p}}{\partial \overline{l}} \cdot \frac{{F}_{o}^{M}}{{l}_{o}^{M}} , & ( 23 ) \\ {k}^{T} = \frac{\partial {f}_{t}}{\partial ɛ} \cdot \frac{{F}_{o}^{M}}{{l}_{s}^{T}} . & ( 24 )\end{matrix}$$

The fiber length is updated (l^{M}±dl^{M}) and the force error recomputed. This procedure is performed iteratively until the percentage force error is less than the specified tolerance

$$( \frac{{F}_{err}}{{F}_{o}^{M}} < tol ) .$$

It is observed that convergence to a solution is usually obtained in less than 5 iterations. See S. L. Delp and J. P. Loan, “A graphics-based software system to develop and analyze models of musculoskeletal structures”, Comput. Biol. Med. (1995), 25(1):21-34, the content of which is incorporated by reference herein in its entirety.

### Muscle Force Distribution

Determination of muscle forces that produce a measured movement is important to characterize the underlying biomechanical function of muscles, to compute the energetic cost of movement at the muscle level as well as to estimate the internal joint loadings that arise. Unfortunately muscle forces cannot be measured directly using non-invasive techniques. In response, the biomechanical model module 140 applies various techniques to estimate muscle forces.

In a first embodiment, the biomechanical model module 140 measures the kinematics and kinetics arising during a task and then uses an inverse dynamics model to compute the joint moments that must have been produced by internal structures (muscles and ligaments). Using a model of the musculoskeletal geometry, the biomechanical model module 140 can then mathematically relate ligament and muscle forces to the net joint moments. Ligament loads, which in healthy adults are small when not near the limits of joint ranges of motion, are often neglected.

In a second embodiment, the biomechanical model module 140 finds a solution that minimizes the sum of muscle stresses raised to a power. See R. D. Crowninshield and R. A. Brand, “A physiologically based criterion of muscle force prediction in locomotion”, Journal of Biomechanics (1981) 14:793-801, the content of which is incorporated by reference herein in its entirety. The justification for this cost function is the observation that muscle contraction duration (endurance) is inversely related to muscle contraction force. By minimizing the sum of muscle stresses squared or cubed, high individual muscle stresses are penalized pushing the solution to one that involves more load sharing between muscles. Correspondingly it is believed that this load sharing then increases one's endurance to perform a task. It has been demonstrated that this approach predicted muscle forces that qualitatively agreed with the timing of electromyographic (EMG) activity during normal gait.

In a third embodiment, the biomechanical model module 140 expands on the technique of the second embodiment by incorporating the force-length and force-velocity properties of muscle. See F. Anderson and M. Pandy, “Dynamic optimization of human walking”, Journal of Biomechanical Engineering (2001), 123:381-390, the content of which is incorporated by reference herein in its entirety. Instead of minimizing the sum of stresses raised to a power, the biomechanical model module 140 minimized the sum of muscle activations raised to a power, which is a more general representation of the active neural drive to the muscle. When compared to a dynamic optimization solution to gait that minimized metabolic energy cost, it was shown that the static optimization solution was remarkably similar, producing realistic estimates of the muscle forces and joint loads seen in gait. See F. Anderson and M. Pandy, “Static and dynamic optimization solutions for gait are practically equivalent”, Journal of Biomechanics (2001), 34:153-161, the content of which is incorporated by reference herein in its entirety. Consequently, inverse dynamics followed by static optimization to solve muscle redundancy seems a reasonable approach to estimating internal muscle forces during gait in healthy adults. This approach is approximate and should be compared with experimental data when possible and should be interpreted with appropriate caution when detailed quantitative measures of muscle and joint loads are being used. Additional information about calculating muscle force distribution and other biomechanical quantities are available in U.S. Pat. No. 7,251,593, the content of which is incorporated by reference herein in its entirety.

### Example Implementation of Muscle Force Distribution

It is assumed that the kinematics (joint angles, angular velocities) of a task have been measured and used to compute the net joint moments acting about the joints. Ignoring ligament forces, mechanical equilibrium requires that the joint moments computed using inverse dynamics be produced by muscle forces.

$${M}_{j} = {\sum }_{i = 1}^{m} {F}_{i}^{T} ( {a}_{i} ) \cdot {r}_{i , j} , \qquad ( 25 )$$

where m is the number of muscles crossing the joint, r_{i,j} is the moment arm of muscle i with respect to generalized coordinate j, and Fᵢ^{T} is the tendon force applied to the bone. An important component of the muscle force distribution problem is the capacity of the muscle to generate a moment about a joint. This capacity is dependent on musculoskeletal geometry, specifically the moment arm of a muscle about a joint.

In one embodiment, moment arms about joints are computed numerically by determining the variation of muscle length with generalized coordinates (joint angles). The moment arm of muscle i with respect to the DOF corresponding to the j^{th} generalized coordinate is given by

$${r}_{i , j} = \frac{\partial {l}_{i}}{\partial {q}_{j}} , \qquad ( 26 )$$

where lᵢ is the overall length of the i^{th} musculo-tendon actuator and qⱼ is the j^{th} generalized coordinate. In many cases, generalized coordinates correspond to joint angles, but they can also be translational units. The advantage of using Equation 26 for computing the moment arm is that joints with changing joint centers (due to translation in the center of rotation) can also have their moment arms computed.

With a skeleton in a specified state, joint kinematics can be used to estimate the overall musculo-tendon length and velocity. The resulting tendon force can then be computed from activation using the force-length-velocity-activation relationship of the muscle.

As mentioned earlier, the number of muscles (m) exceeds the number of DOF (n) making the solution for the muscle forces indeterminate and overconstrained. The biomechanical model module 140 may be set up to find the muscle activation levels (aᵢ) that satisfy moment equilibrium while minimizing a cost function. While any cost function can be applied, the biomechanical model module 140 currently minimizes the sum of muscle activations squared, as illustrated in the equation below:

$$J = {\sum }_{i = 1}^{m} {a}_{i}^{2} . \qquad ( 27 )$$

The optimization problem is solved using constrained nonlinear optimization. In the optimization problem, activation levels for individual muscles are constrained to be between 0.001 and 1.0. A gradient-based technique is used to numerically seek the muscle activations that minimize the cost function J while also satisfying joint moment equilibrium for all DOF of interest. The most computationally demanding part of the optimization problem is computing the gradients of the joint moment equality constraints with respect to the activations of each of the muscles. Because of the nonlinear nature of the musculo-tendon properties, gradients cannot be computed analytically but are estimated using central finite difference techniques:

$$\frac{\partial {M}_{j}}{\partial {a}_{i}} = \frac{{M}_{j} ( {a}_{i} + δ a ) - {M}_{j} ( {a}_{i} - δ a )}{2 δ a} . \qquad ( 28 )$$

Applying the above approach, it takes approximately 10 minutes of computational time to solve the muscle force distribution problem for 100 frames of normal gait. Because this technique is slow relative to other analysis of the biomechanical model module 140 (e.g., inverse dynamics), the biomechanical model module 140 may be configured to solve the muscle force distribution off-line, by storing the muscle activations in a motion file and then reloading into system memory to compute other measures of interest (metabolic energy rates, mechanical work) or to drive 3D models of muscle.

### Evaluation Module

The evaluation module 150 is configured for evaluating subject's reconstructed pose based on the physical and/or physiological quantities received from the biomechanical model module 140. The evaluation module 150 compares the subject's reconstructed pose trajectory with the guided pose trajectory. The guided pose trajectory is obtained by a virtual (or actual) therapist from a database of predefined trajectories. The trajectory comparison may be in configuration space or in task space. The evaluation module 150 may compare kinematic metrics such as differences in trajectory, in velocity, and/or in acceleration. Other kinematic metrics may be obtained as a way to describe similarity between the guided trajectory and the actual trajectory. These may include dynamic time warping algorithms and Hidden Markov Model (HMM) algorithms.

The evaluation module 150 can also use the configuration space or task space trajectories to compute physical quantities such as joint torque, joint power, and mechanical stress/strain. These quantities can further be used to compute the mechanical energy expended. Mechanical energy can be converted to more recognizable quantities such as Calories, or Joules.

The evaluation module 150 can use the computed joint torque in conjunction with a musculoskeletal model of the subject to determine the muscle forces and muscle activation patterns. Biomechanical quantities such as muscle fatigue, endurance, metabolic effort can be computed from musculoskeletal models.

The evaluation results can be transmitted to the expert agent module 160 to be displayed to the subject and used for personal evaluation. The evaluation results can also be stored in a personal database for the subject. In addition, the evaluation results can be provided to an expert (e.g., a doctor) for additional in-depth analysis.

### Expert Agent Module

The expert agent module 160 provides a virtual environment for the subject to participate in guided rehabilitation programs and receive real-time feedback. The expert agent module 160 provides a user interface (UI) to enable the subject to interact with the virtual rehabilitation system 100 and to provide the virtual environment. The subject can interact with the UI (e.g., via voice command or gesture command) to provide inputs (e.g., selecting rehabilitation programs).

The UI includes graphical UI (GUI) for personal information, training programs, avatar display, results interface, and operation interface. The GUI for personal information enables the subject to review personal information such as name, age, gender, height, weight, and medical history. The subject may also input additional personal information and/or modify existing information through the GUI. The GUI for training programs provides the subject with various exercises appropriate for the subject, such as balance exercise, movement reproduction, and motion sequence recall. A more extensive list of rehabilitation programs provided by the virtual rehabilitation system 100 is listed in the following section. The programs can be demonstrated by an avatar or instructed via voice commands. The GUI for operation interface provides the subject with functions such as recording data (e.g., motions), controlling training programs (e.g., play, stop, pause, start), and controlling the viewing angle (e.g., of the avatar).

The GUI for avatar display displays a general or subject-specific avatar (e.g., based on the subject's voice commands), or a physical robot. The GUI displays online reconstructed movements of the subject mapped to the avatar (actual trajectory), along with reference (or pre-defined) movements mapped to the avatar (reference trajectory or guide trajectory). The two trajectory (actual and reference) can be superimposed on a same avatar or on two avatars. In addition, the GUI also displays the differences between the two trajectories. The error (or difference between the instructed movements and the actual movements) is displayed through an avatar or by plotting the difference. In order to challenge the subject further, the displayed error can be amplified or exaggerated.

The GUI for results interface provides the evaluation results of the subject for participating the rehabilitation programs. The expert agent module 160 graphically displays quantities/metrics such as COP, COG, joint torques, joint power, mechanical energy expenditure, and metabolic energy expenditure. These measurements can be specific to the subject (e.g., age, gender), and can be superimposed on the avatar, displayed as a bar graph or a time history diagram. Additionally, the expert agent module 160 can display the quantitative evaluation results such as the calories used, the percentage of the training program completed. The expert agent module 160 can also display statistical data such as a position tracking metric, a velocity tracking metric, and a balance keeping metric.

The UI of the expert agent module 160 may also include a dialogue system that provides voice instruction to the subject (e.g., via the speaker 125) and receives voice commands from the subject (e.g., via a microphone). In one embodiment, the expert agent module 160 uses the metrics used to evaluate the subject's performance to provide audio feedback to the subject. The audio feedback may come from an expert person or the expert agent module 160. The audio feedback may provide guidance, such as move slower or faster, or it may provide encouragement and motivation. The expert agent module 160 may also receive evaluation result information from expert and subject information from a medical and performance history database.

The UI of the expert agent module 160 may also include other user interface such as haptic devices for the subject to use in physical interactions and thus provide the subject with resistive trainings in an immersive virtual environment. In addition, the UI of the expert agent module 160 may also include a physical robot that replicates the subject's movements. The physical robot can also be used to provide physical interaction, physical assistance, and resistive training

### Example Therapy/Training

Below is an incomplete list of rehabilitation programs that can be offered by the virtual rehabilitation system 100. One skilled in the art will readily recognize from the description herein that the virtual rehabilitation system 100 can provide other training programs.

### Mirror Therapy

The subject moves one or several limbs on one side of the body. The pose estimation software detects the pose of the limbs in motion. The motion of an avatar (or person's own image model) is created so that the subject's limb motion and the mirror image motion of the other limbs are displayed to the subject on a monitor. For example, if the subject moves the right arm only, the avatar displays the reconstructed motion of the right arm as well as its mirror motion of the left arm. Mirror therapy can be used for reducing phantom pains and improving mobility of patients suffering from certain neurological disorders such as stroke.

### Balance & Stability Based on Regulation of COP and COG

Regulation of the trajectory of center of pressure (COP) and center of gravity (COG) to a desired reference trajectory is an important form of balance exercise. Such an exercise can also be therapeutic for people that have a dysfunction of postural balance or are prone to falls. The pose estimation software determines the configuration of the body in real time as the subject executes a motion. The joint motion and its derivatives are applied to a physics engine which computes the COP and COG. The COP and COG are displayed to the subject. A desired (or reference) trajectory of the COP or COG is also displayed to the subject. The subject is asked to coordinate their limb motion such that the resulting COP and COG track the reference trajectories.

### Balance & Stability Based on Pose Regulation

In human posture estimation, by measuring small movements in key-points (e.g., foot, hand, elbow), a computer module can identify if the person is stably taking that posture or not. For example, the subject is requested to stand on one leg and make open-arm gesture for 5 seconds. The computer software will assess how immobile the subject was during that period. This type of information is useful in games and rehabilitation e.g., stably taking postures get high points in the game.

### Motion Sequence Recall

A subject (patient or game player) is requested to take a sequence of postures (by remembering the posture sequence). The computer software can identify which postures were taken and which postures were skipped (forgotten), how correct the sequence (order of postures) was, thus being able to rate the subject ability of re-creating a given posture sequence. This type of operation is useful in games and rehabilitation (to test body memory).

### Voice and Posture

A subject (patient or game player) is requested to make a certain pose and make an utterance simultaneously or by a given sequence. The computer software module will evaluate the posture and timing of utterance (as picked up by a voice recognition software) to make an assessment regarding how accurately the subject can execute motion and utterance. This function may be used in games (subject gets higher scores, when doing such a combination/sequence accurately).

### Posture and Hand Shape

Subject takes posture and makes a certain hand shape. The posture detection module isolates the hand region such that the hand can be segmented from other body parts and from the background. Hand shape analysis is performed to determine the “hand state” (open or closed) as well as hand posture and orientation.

### Listening to Words and Gesture

A subject is to listen to a sequence of words (or tone or chimes) coming out from the computer system. A specific word is associated with a specific posture. The subject (a game player or patient) is to take the posture associated with a word, when he hears that word. This will make the patient alert in listening and keep him ready to move his body. This system allows the person to exercise body and cognitive (listening) skill simultaneously.

### Additional Embodiments

The above embodiments describe a virtual rehabilitation system for providing a patient with a virtual environment in which the patient can participate in guided rehabilitation programs and receive real-time feedback. One skilled in the art would understand that the described embodiments can be used for general purpose training programs (e.g., fitness programs) and entertainment programs (e.g., games).

Some portions of above description describe the embodiments in terms of algorithmic processes or operations, for example, the processes and operations as described with FIGS. 1-3.

One embodiment of the present invention is described above with reference to the figures where like reference numbers indicate identical or functionally similar elements. Also in the figures, the left most digits of each reference number corresponds to the figure in which the reference number is first used.

Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems. The invention can also be in a computer program product which can be executed on a computing system.

The present invention also relates to an apparatus for performing the operations herein. This apparatus may be specially constructed for the purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A computer based method for providing a human user with a guided movement and feedback, the method comprising:
providing to the user an instruction to perform the guided movement;
capturing a movement performed by the user in response to the instruction;
estimating a movement of the user in a human model based on the captured movement performed by the user;
determining a biomechanical quantity of the user by analyzing the estimated movement in the human model; and
providing feedback to the user about the captured movement performed by the user based on the biomechanical quantity.

2. The method of claim 1, wherein capturing the movement comprises capturing the movement in a depth image stream using a depth camera, and wherein estimating the movement of the user comprises:
detecting features in the depth image stream and representing the detected features by position vectors;
filtering the position vectors to generate interpolated position vectors;
augmenting the interpolated position vectors with positions of features missing in the depth image stream; and
generating an estimated movement of the user based on the augmented position vectors.

3. The method of claim 2, wherein the features are detected by comparing Inner Distance Shape Context (IDSC) descriptors of sample contour points with IDSC descriptors of known feature points for similarity.

4. The method of claim 3, wherein the feature point comprises one of: head top, left shoulder, right shoulder, left elbow, right elbow, left wrist, right wrist, left waist, right waist, groin, left knee, right knee, left ankle, and right ankle

5. The method of claim 1, wherein the human model is a human anatomical model that closely resembles the body of the user.

6. The method of claim 5, wherein the human model is configured based on a plurality of appropriate kinematic model parameters and appropriate dynamic model parameters of a plurality of body parts of the user.

7. The method of claim 6, wherein one or more of the plurality of appropriate kinematic model parameters are obtained from images of the user.

8. The method of claim 1, wherein the biomechanical quantity comprises a center of pressure (COP) and the COP is determined using a Recursive Newton-Euler Algorithm (RNEA).

9. The method of claim 1, wherein the biomechanical quantity comprises a muscle force, and the muscle force is determined by modeling muscle and tendon mechanics as active force-generating elements in series and parallel with elastic elements.

10. The method of claim 9, wherein the muscle force is determined using a generic musculo-tendon model that is scaled to individual muscles using the following muscle specific parameters: a maximum isometric force capacity of muscle, an optimal muscle fiber length, a muscle fiber pennation angle at optimal fiber length, and a tendon slack length.

11. The method of claim 9, wherein determining the muscle force comprises iteratively updating the fiber length and recomputing a percentage force error until the percentage force error is less than a predetermined value.

12. The method of claim 1, wherein providing the feedback comprises:
displaying a human model tracking the estimated movement of the user along with the guided movement.

13. The method of claim 11, wherein providing the feedback further comprises:
amplifying the differences between the estimated movement and the guided movement.

14. The method of claim 1, further comprising:
transmitting the biomechanical quantity to a human expert, wherein the feedback comprises feedback provided by the human expert in response to the biomechanical quantity.

15. The method of claim 1, wherein the instruction to perform the guided movement comprises one of a voice command and a motion command graphically displayed to the user by means of the human model.

16. The method of claim 1, wherein the feedback comprises a physical robot that replicates the subject's movements.

17. The method of claim 16, wherein the physical robot is further configured to provide at least one of the following: physical interaction, physical assistance, and resistive training

18. The method of claim 1, wherein the guided movement comprises one of the following: mirror therapy, balance & stability based on regulation of the center of pressure (COP) and the center of gravity (COG), balance & stability based on pose regulation, motion sequence recall, voice and posture, posture and hand shape, and listening to words and gesture.

19. A computer program product for providing a human user with a guided movement and feedback, the computer program product comprising a computer-readable storage medium containing executable computer program code for performing a method comprising:
providing to the user an instruction to perform the guided movement;
capturing a movement performed by the user in response to the instruction;
estimating a movement of the user in a human model based on the captured movement performed by the user;
determining a biomechanical quantity of the user by analyzing the estimated movement in the human model; and
providing feedback to the user about the captured movement performed by the user based on the biomechanical quantity.

20. A system for providing a human user with a guided movement and feedback, the system comprising:
a computer processor for executing executable computer program code;
a computer-readable storage medium containing the executable computer program code for performing a method comprising:
providing to the user an instruction to perform the guided movement;
capturing a movement performed by the user in response to the instruction;
estimating a movement of the user in a human model based on the captured movement performed by the user;
determining a biomechanical quantity of the user by analyzing the estimated movement in the human model; and
providing feedback to the user about the captured movement performed by the user based on the biomechanical quantity.
